(19) United States
(12) Patent Application Publication
(10) Pub. No.: US 2017/0161355 A1
(43) Pub. Date: Jun. 8, 2017

(54) SYSTEM AND NETWORK FOR TRANSFORMING RELATIONAL DATA WITHIN A RELATIONAL DATABASE

(71) Applicant: Bank of America Corporation, Charlotte, NC (US)

(72) Inventors: Rudolph G. Schreyer, Robbinsville, NJ (US); Craig C. Fuller, Peapack, NJ (US); Terence F. McKnight, Richboro, PA (US); Robert R. Hennessy, Langhorne, PA (US)

(21) Appl. No.: 14/960,936

(22) Filed: Dec. 7, 2015

(51) Int. Cl. G06F 17/30

(52) U.S. Cl. CPC G06F 17/30595; G06F 17/30321; G06F 17/30371; G06F 17/30377; G06F 17/30368

(57) ABSTRACT

Systems and computer-readable media are disclosed for generating relational data structures including aggregating relationship information for one or more clients within a relational database, and utilizing the relationship information to trigger one or more downstream processes. The relational structures may be validated prior to triggering downstream processes. The downstream processes may be automatically triggered. In some embodiments, an existing relational structure may be modified to include updated relationship data. The updated relational structure may trigger additional downstream workflow processes.

### BACKGROUND

Aspects of the disclosure relate to computer hardware and software. In particular, one or more aspects of the disclosure generally relate to computer hardware and software for transforming relational data for one or more clients.

An advisor often may provide clients with various products and services. The products and services provided to a particular client may be customized by the advisor in view of the client's requirements and objectives. An advisor may wish to have a comprehensive and precise characterization of a client's status. This may include, for instance, information about the client's current and future holdings.

However, such a characterization may be incomplete, in that information regarding the client's relationship to a second client may not be included. Additionally absent from this type of characterization is information regarding the client's relationship to the holdings of the second client. This incomplete view of the client's status may detrimentally affect the advisor's ability to effectively advise the client. In many instances, however, it may be advantageous to aggregate information indicative of a first client's relationship to another client. It may further be advantageous to aggregate information indicative of a first client's relationship to the holdings of the second client. A new relational data structure containing one or more data fields may be created within a central database, and the one or more data fields of the relational structure may be propagated with the aggregated relationship information.

The central database may hold multiple relational structures for each client, and each relational structure maintained for a client may contain relationship information for that client. An advisor may access the information from the central database in order to view a comprehensive characterization of a client's status.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to various systems and techniques that provide effective, efficient, and convenient ways of transforming relationship data in order to trigger downstream processes. In at least some aspects, transforming the relationship data may include modifying a structure within a database or generating a new database structure in order to facilitate downstream processes.

Aspects of the disclosure relate to enabling one or more computer systems of an enterprise organization to receive, from a first computing device, relationship information defining a relationship between two clients, the relationship information including a relationship type and one or more relationship traits. The one or more computer systems of the enterprise organization may create a new relational structure within a central base and propagate one or more data fields of the new relational structure with the relationship information. The one or more computer systems of the enterprise organization may further trigger one or more workflow processes based on the relationship information.

For example, in accordance with one or more aspects of the disclosure, a first computing platform including at least one processor, a communication interface, and memory may receive, from a first computing device, relationship information defining a relationship between two clients, the relationship information including a relationship type and one or more relationship traits. The computing platform may create a new relational structure within a central base and propagate one or more data fields of the new relational structure with the relationship information. The computing platform may further trigger one or more workflow processes based on the relationship information.

In some instances, triggering the one or more workflow processes based on the relationship information may include automatically sending a trigger to a second computing device. In some instances, triggering the one or more workflow processes based on the relationship information may include sending a request for permission to trigger the one or more workflow processes to the first computing device. In some instances, triggering the one or more workflow processes based on the relationship information may include sending a trigger for a first downstream process to a second computing device and triggering, by the second computing device, a second downstream process. Triggering, by the second computing device, a second downstream process may include sending, by the second computing device, a notification to the first computing device.

In some instances, the computing platform may validate the new relational structure using one or more constraints stored in the central database. A first constraint of the one or more constraints restricts permissible relationship traits based on the relationship type. In some instances, the computing platform may automatically transmit, to the first computing device and in response to the new relational structure being successfully validated, a notification indicating that the new relational structure has been created. In some instances, the computing platform may automatically transmit, to the first computing device and in response to the new relational structure failing to be validated, a request for updated relationship data.

In accordance with one or more embodiments, a system may include at least one processor, a communication interface, and memory storing computer-readable instructions that, when executed by the at least one processor, cause the system to receive, from a first computing device, relationship information defining a relationship between two clients, the relationship information including a relationship type and one or more relationship traits. The memory may store additional computer-readable instructions that, when executed by the at least one processor, further cause the system to create a new relational structure within a central base, propagate one or more data fields of the new relational structure with the relationship information, and trigger one or more workflow processes based on the relationship information.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative computing environment for transforming data, including aggregating and utilizing relationship data between clients in accordance with one or more aspects described herein;

FIG. 2 depicts an illustrative relational structure and metadata structure that may be stored in a relational database in accordance with one or more aspects described herein;

FIG. 3 depicts an illustrative method for creating a new relational structure in accordance with one or more aspects described herein;

FIG. 4 depicts an illustrative method for updating an existing relational structure in accordance with one or more aspects described herein;

FIG. 5 depicts an illustrative operating environment in which various aspects of the disclosure may be implemented in accordance with one or more example embodiments; and

FIG. 6 depicts an illustrative block diagram of workstations and servers that may be used to implement the processes and functions of certain aspects of the present disclosure in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

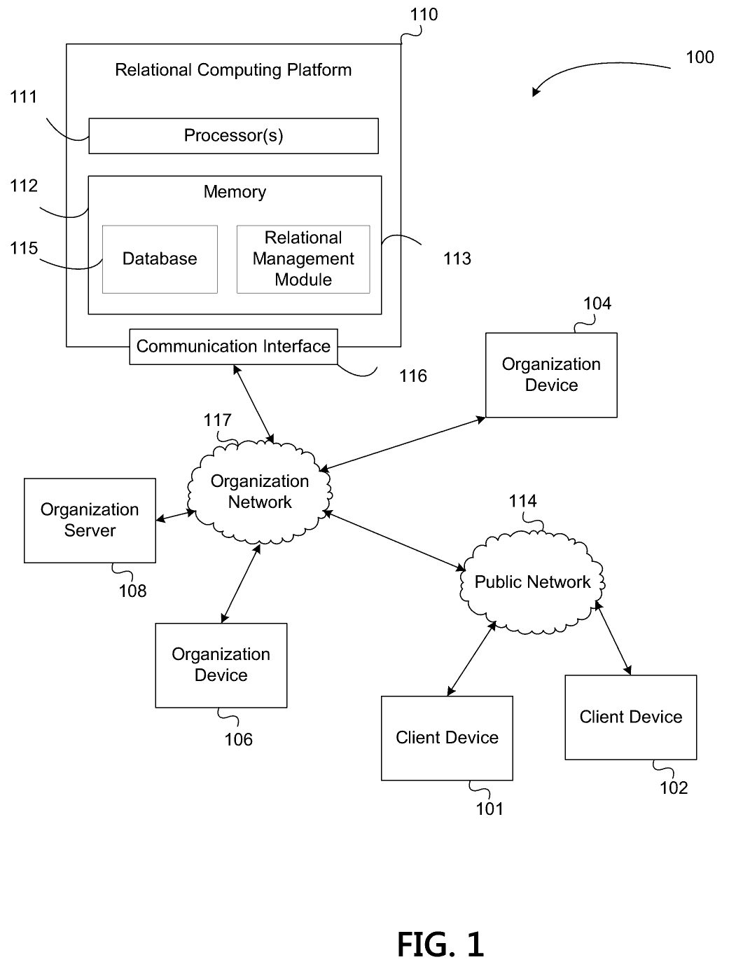

FIG. 1 depicts an illustrative computing environment for creating, updating, and utilizing relationship information for one or more users in accordance with one or more example embodiments. Referring to FIG. 1, computing environment 100 may include one or more computing devices and servers. For example, computing environment 100 may include a first client device 101, and a second client device 102, a first organization device 104, and a second organization device 106. First client device 101 and second client device 102 may be used by one or more clients of an enterprise organization. First organization device 104 and second organization device 106 may be used by one or more advisors associated with the enterprise organization. Computing environment 100 may further include organization server 108. Organization server 108 may store information related to the enterprise organization, including information about clients of the enterprise organization and accounts associated with the clients of the enterprise organization.

First client device 101, second client device 102, first organization device 104, and second organization device 106 may be any type of computing device configured to provide the particular functionality described herein. For instance, the first client device 101, second client device 102, first organization device 104 and/or second organization device 106 may be a device configured to receive and/or display a user interface, receive input via the user interface, and communicate the received input to one or more other computing devices. For example, first client device 101, second client device 102, first organization device 104, and second organization device 106 may be a server computer, a desktop computer, laptop computer, tablet computer, smart phone, or the like. Any and/or all of first client device 101, second client device 102, first organization device 104, and second organization device 106 may, in some instances, be special-purpose computing devices configured to perform specific functions.

Computing environment 100 also may include one or more computing platforms. For example, computing environment 100 may include relational computing platform 110. Relational computing platform 110 may include one or more computing devices configured to perform one or more of the functions described herein. For example, relational computing platform 110 may include one or more computers (e.g., laptop computers, desktop computers, servers, server blades, or the like).

Computing environment 100 also may include one or more networks, which may interconnect one or more of relational computing platform 110, first client device 101, second client device 102, first organization device 104, second organization device 106, and organization server 108. For example, computing environment 100 may include organization network 117 and public network 114. Organization network 117 and/or public network 114 may include one or more sub-networks (e.g., LANs, WANs, or the like). Organization network 117 may be associated with a particular organization (e.g., a corporation, enterprise organization, educational institution, governmental institution, or the like) and may interconnect one or more computing devices associated with the organization. For example, relational computing platform 110, first organization device 104, second organization device 106, and organization server 108, may be associated with an organization (e.g., a enterprise organization), and organization network 117 may be associated with and/or operated by the organization, and may include one or more networks (e.g., the Internet, LANs, WANs, VPNs, or the like) that interconnect relational computing platform 110, first organization device 104, second organization device 106, one or more other computing devices and/or computer systems that are used by, operated by, and/or otherwise associated with the organization.

Public network 114 may connect organization network 117 and/or one or more computing devices connected thereto (e.g., relational computing platform 110, first organization device 104, second organization device 106) with one or more networks and/or computing devices that are not associated with the organization. Public network 114 may include one or more networks (e.g., the Internet) that connect external computing devices connected thereto (e.g. first client device 101 and second client device 102) to organization network 117 and/or one or more computing devices connected thereto (e.g., relational computing platform 110, first organization device 104, and second organization device 106).

Relational computing platform 110 may include one or more processors 111, memory 112, and communication interface 116. A data bus may interconnect processor(s) 111, memory 112, and communication interface 116. Communication interface 116 may be a network interface configured to support communication between relational computing platform 110 and organization network 117 and/or one or more sub-networks thereof. Memory 112 may include one or more modules having instructions that when executed by processor(s) 111 cause relational computing platform 110 to perform one or more functions described herein and/or one or more databases that may store and/or otherwise maintain information which may be used by such modules and/or processor(s) 111. For example, memory 112 may include relational management module 113, which may include instructions that when executed by processor(s) 111 cause relational computing platform 110 to perform one or more functions described herein, such as instructions for receiving relationship data, creating a relational structure within relational database 115 for the relationship data, validating the relational structure, sending notifications that the relational structure has been created and/or validated, and triggering downstream processes, as illustrated in greater detail below. In addition, memory 112 may include a relational database 115, which may store relationship information associated with one or more clients. Relational database 115 may be a central database that may be accessed by relational computing platform 110 and additional computing devices associated with the organization, such as first organization device 104 and second organization device 106.

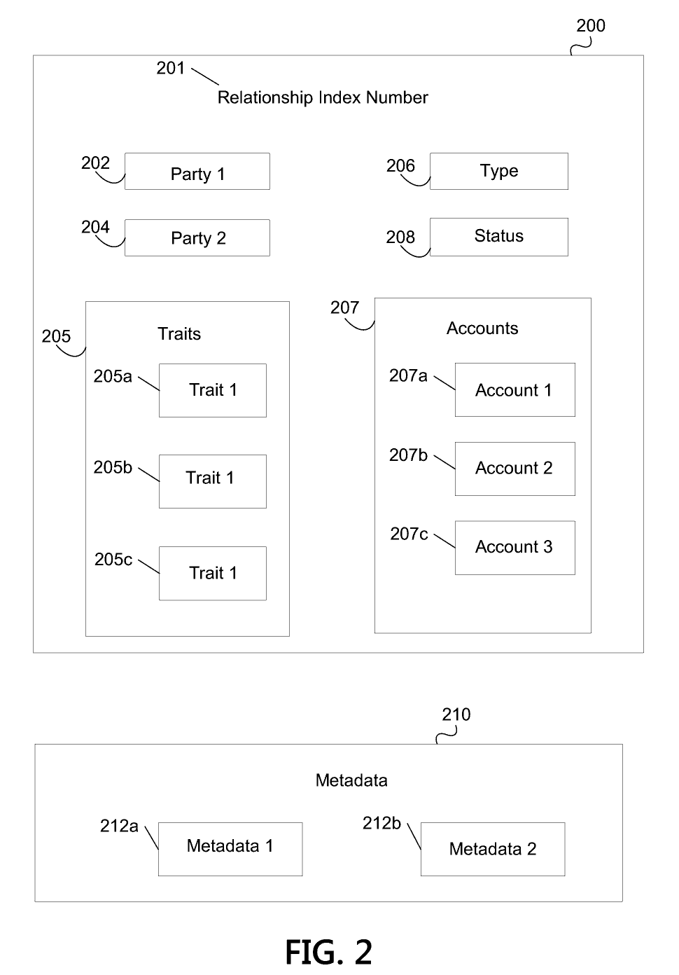

FIG. 2 depicts an exemplary relational structure 200 and metadata structure 210 that may be stored in the relational database 115 of relational computing platform 110. Relational database 115 may store one or more of the depicted relational structure 200. Each instance of relational structure 200 stored in relational database 115 of relational computing platform 110 may be associated with a client of the enterprise organization or a non-client of the enterprise organization. The client or non-client may be an individual or an organization. In turn, a client or non-client may be associated with multiple relational structures 200.

Each instance of relational structure 200 may include a relationship index number 201. Relationship index number 201 may serve as an identification of each instance of relational structure 200. Each relationship index number 201 of the plurality of relational structures 200 may be used by relational database 115 to index the plurality of relational structures 200 that are stored in relational database 115. Relationship index number 201 may be an identification number, or may be a name of the client or non-client with whom the relational structure 200 is associated, or other unique identifier associated with the client.

Relational structure 200 may further include data field 202 and data field 204. Data field 202 may contain the name of a first party. The first party may be a client with whom the relational structure 200 is associated, or may be a non-client. The first party may be an individual or an organization, such as a business entity. Data field 202 may further include an indication of whether the first party is an individual or an organization. Data field 202 may further include contact information for the party in data field 202, such as address, one or more telephone numbers, and an email address. Data field 202 may further include an identification number associated with the party in data field 202. This identification number may be linked to additional information that is associated with the party in data field 202. The additional information that is associated with the party in data field 202 may be stored in an organization database or server. The additional information may indicate whether the party in data field 202 is a client of the enterprise organization or whether the party in data field 202 is a non-client of the enterprise organization.

Data field 204 may contain the name of a second party. The second party may be an individual or an organization, such as a business entity. The second party may be an individual or affiliate that has a relationship with the party in data field 202. Data field 204 may further include an indication of whether the second party is an individual or an organization. Data field 204 may further include contact information for the party in data field 204, such as address, one or more telephone numbers, and an email address. Data field 204 may further include an identification number associated with the party in data field 204. This identification number may be linked to additional information that is associated with the party in data field 204. The additional information that is associated with the party in data field 204 may be stored in an organization database or server. The additional information may indicate whether the party in data field 204 is a client of the enterprise organization or whether the party in data field 204 is a non-client of the enterprise organization.

Relational structure 200 may further include data field 206. Data field 206 may include the type of relationship between the party in data field 202 and the party in data field 204. One or more types of valid relationships may be previously been specified by the enterprise organization for whom relational database 115 is maintained. Data field 206 may then contain any one of the valid relationship types that have been previously specified. The previously specified types of valid relationships may be stored within metadata structure 210 of relational database 115 of relational computing platform 110. Data field 206 may specify the relationship of the party in data field f202 to the party in data field 204, or vice versa, data field 206 may specify the relationship of the party in data field 204 to the party in data field 202.

In one instance, the enterprise organization may have previously specified a plurality of valid familial-type relationships, such as father, mother, child, brother, sister, and/or spouse. In a first example, the party in data field 202 may be the spouse of the party in data field 204. Accordingly, data field 206 may indicate a relationship type of “spouse.” In a second example, the party in data field 204 may be the child of the party in data field 202. Accordingly, data field 206 may indicate a relationship type of “child.” Additionally, or alternatively, the enterprise organization may have previously specified a plurality of valid professional-type relationships, such as accountant or lawyer. In one example, the party in data field 204 may be the attorney of the party in data field 202. Accordingly, data field 206 may indicate a relationship type of “attorney.” Additionally, or alternatively, the enterprise organization may have previously other relationship types, such as trustee, beneficiary, parent company, or child company. In one example, the party in data field 204 may act as a trustee for the party in data field 202. Accordingly, data field 206 may indicate a relationship type of “trustee.” In a second example, data field 202 may contain the name of a first business entity, data field 204 may contain the name of a second business entity, and data field 206 may indicate that the party in data field 204 is the parent company of the party in data field 202.

Data field 208 may indicate the status of the relationship specified in data field 206. The status may indicate whether the relationship is active, or whether the relationship will vest on a certain date. For example, if the party in data field 204 is currently married to the party in data field 202, then data field 208 may indicate that the relationship is “active.” In a second example, the party in data field 204 will become a trustee for the party in data field 202 on a future date. In such a case, data field 208 may indicate the date on which the party in data field 204 will become the trustee. In a third example, the party in data field 202 may be a first business entity and the party in data field 204 may be a second business entity. The second business entity may be set to acquire the first business entity on a future date. In such a case, data field 208 may indicate the date on which the party in data field 204 will become the parent company of the party in data field 202.

Data field 205 may indicate additional traits of the relationship between the party in data field 202 and the party in data field 204. These additional traits are shown as elements 205a-c, but additional or fewer traits may be included. The enterprise organization may have previously specified one or more traits that are valid for different relationship types. This may previously have been stored within metadata structure 210 in relational database 115 of relational computing platform 110. In one instance, an individual in data field 204 may be the spouse of an individual in data field 202. Data field 206 may indicate that the party in data field 204 is the “spouse” of the party in data field 202, and data field 208 may indicate that the relationship is “active.”

However, the individual in data field 204 may have additional relationships to the individual in data field 202. For example, trait 205a may indicate that the individual in data field 204 is the beneficiary of the individual in data field 202. Trait 205b may indicate that the individual in data field 204 also holds power of attorney for the individual in data field 202. Trait 205c may indicate that the party in data field 204 has third-party access to the accounts held by the party in data field 202. An additional trait in data field 205 (not shown) may indicate that the party in data field 204 is joint-owner of one or more accounts listed in data field 207 (discussed below). In a second example, an individual in data field 204 may be the child of the party in data field 202. In this example, trait 205a may indicate that the individual in data field 204 is also a beneficiary of the individual in data field 202, and trait 205b may indicate that the individual in data field 204 is a dependent of the party in data field 202.

Data field 207 may include a list of the accounts maintained by the party in data field 202 and/or the party in data field 204. The accounts may be self-managed (i.e. managed by the party in the data field 202 or the party in data field 204) or may be full-service accounts (i.e. managed by an advisor associated with the enterprise organization on behalf of the party in data field 202 or the party in data field 204). The accounts may be associated with the enterprise organization, or may be maintained by third parties. The accounts may include banking accounts (such as checking or savings) and/or brokerage accounts (such as stocks, bonds, money market instruments, real estate, commodities, and/or retirement plans), or other types of financial holdings associated with the party in data field 202 or data field 204. For example, element 207a may represent a self-managed savings account associated with the party in data field 202. Element 207b may represent a self-managed checking account associated with the party in data field 202. Element 207c may represent a full-service retirement account associated with the party in data field 204 and managed by an advisor of the enterprise organization.

Metadata structure 210 may also be stored in the relational database 115 of relational computing platform 110. Metadata structure 210 may store one or more data fields of metadata that may be used to validate each relational structure 200. Each data field within metadata structure 210 may store one or more rules. These rules may be associated with one or more data fields of the relational structures 200. For example, as noted above, the enterprise organization may have previously specified valid types of relationships, and these may be stored as metadata within relational database 115 of relational computing platform 110. The enterprise organization may also have previously specified certain types of traits that are applicable to the types of relationships, and these may also be stored in metadata structure 210.

As indicated above, data field 202 includes an indication of whether the party in data field 202 is an individual or a business entity, and data field 204 includes an indication of whether the party in data field 204 is an individual or a business entity. One or more data fields of metadata structure 210 may store rules specifying the valid types of relationships that are allowed between individuals, between business entities, and between individuals and business entities. In one instance, data field 202 may indicate that the party in data field 202 is an individual, and data field 204 may indicate that the party in data field 204 is a business entity. The enterprise organization may have previously specified a rule indicating that a relationship type of “spouse” may only exist if the party in data field 202 and the party in data field 204 of relational structure 200 are both individuals. In one instance, this rule may be stored in data field 212a of metadata structure 210. In this instance, a relationship type of “spouse” would be invalid because the party in data field 202 is an individual, while the party in data field 204 is a business entity.

In another instance, the enterprise organization may have previously specified a rule indicating that a relationship type of “owner” may only exist if one party is an individual and one party is a business entity. This rule may be stored in data field 212b of metadata structure 210. In this instance, a relationship type of “owner” would be valid because the party in data field 202 in an individual and the party in data field 204 is a business entity.

As further indicated above, data field 206 indicates a relationship type between the parties in data field 202 and data field 204, and data field 205 may include additional traits of the relationship. One or more data fields of metadata structure 210 may store rules specifying the traits that are valid (or invalid) for each of the different types of relationships. For example, a first rule stored in a data field 212a of metadata structure 210 may indicate that if the party in data field 204 is the spouse of the party in data field 202, valid traits of a “spouse” relationship include beneficiary, power of attorney, dependent, and third-party access. A second rule stored in a data field 212b of metadata structure 210 may indicate that if the party in data field 204 is the child of the party in data field 202, valid traits of a “child” relationship include beneficiary and dependent. The second rule may further indicate that invalid traits of a “child” relationship include power of attorney and third-party access. These rules are exemplary, and additional rules may be specified by the enterprise organization and stored in metadata structure 210 of relational database 115 of relational computing platform 110.

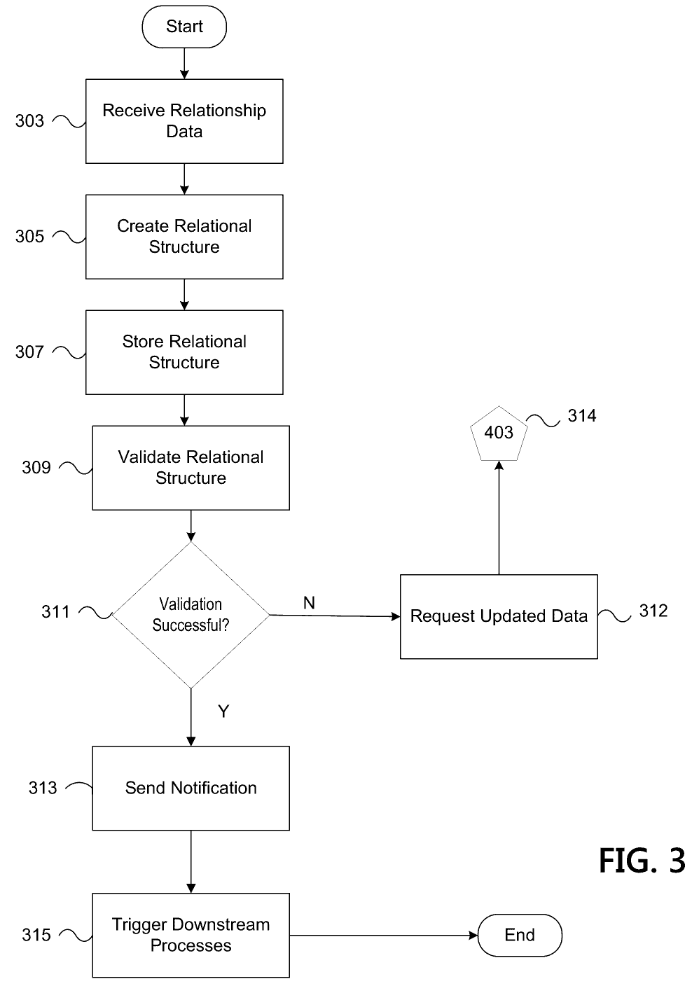

FIG. 3 depicts an illustrative method for creating a new relational structure. At step 303, the relational computing platform 110 may receive information defining a relationship between two clients. At least one client of the two clients may be associated with the enterprise organization. The relational computing platform 110 may receive the information from a client device, such as a first client device 101, or from an organization device, such as first organization device 104.

As noted above, first client device 101 and first organization device 104 may be any type of computing device configured to receive a user interface, receive input via the user interface, and communicate the received input to one or more other computing devices. For example, first client device 101 and first organization device 104 may be a server computer, a desktop computer, laptop computer, tablet computer, smart phone, or the like. Any and/or all of first client device 101 and first organization device 104 may, in some instances, be special-purpose computing devices configured to perform specific functions. A user may input the relationship information via the user interface presented on first client device 101 or first organization device 104.

The information received in step 303 by relational computing platform 110 from first client device 101 or first organization device 104 may include one or more of the name of a first party, the name of a second party, the relationship type, the relationship status, and traits of the relationship. In one instance, the relational computing platform 110 may only need to receive a select subset of these fields to create a relational structure 200 within relational database 115 of relational computing platform 110 (such as the name of a first party, the name of a second party, the relationship type, and the relationship status). The remaining fields, such as traits of the relationship, may be updated at a later time.

At step 305, relational computing platform 110 may create a relational structure 200 using the information received from first client device 101 or first organization device 104. The relational structure 200 may initially be a blank structure. Relational computing platform 110 may then propagate one or more of data field 202, data field 204, data field 205, data field 206, and data field 208 using the information received from first client device 101 or first organization device 104. If relational computing platform 110 receives only a subset of the required data (such as the name of a first party, the name of a second party, the relationship type, and the relationship status), one or more data fields, such as data field 207, may be left blank by relational computing platform 110.

At step 307, relational computing platform 110 may store the created relational structure 200 in relational database 115 of relational computing platform 110. The created relational structure 200 may be indexed by the relational computing platform 110 prior to storing (such as by an identification number or by the name of the party in data field 202) so that the relational structure 200 may be subsequently accessed by relational computing platform 110.

At step 309, relational computing platform 110 may validate the relational structure 200. As noted above, relational database 115 may store metadata structure 210. Metadata structure 210 may store one or more data fields of metadata that may be used to validate each relational structure 200. Each data field within metadata structure 210 may store one or more rules. These rules may be associated with one or more data fields of the relational structures 200. For example, as noted above, the enterprise organization may have previously specified valid types of relationships, and these may be stored in metadata structure 210 within relational database 115 of relational computing platform 110. The enterprise organization may also have previously specified certain types of traits that are applicable to the types of relationships, and these may also be stored in metadata structure 210.

As indicated above, data field 202 includes an indication of whether the party in data field 202 is an individual or a business entity, and data field 204 includes an indication of whether the party in data field 204 is an individual or a business entity. One or more data fields of metadata structure 210 may store rules specifying the valid types of relationships that are allowed between individuals, between business entities, and between individuals and business entities. Relational computing platform 110 may validate the relationship type stored in data field 206 and the relationship traits stored in data field 205 based on these rules from metadata structure 210.

The enterprise organization may have previously specified a rule within metadata structure 210 indicating that a relationship type of “spouse” may only exist if the party in data field 202 and the party in data field 204 of relational structure 200 are both individuals. The enterprise may have further previously specified a rule within metadata structure 210 indicating that a relationship type of “parent company” may only exist if the parties in both data field 202 and data field 204 are business entities.

In one instance, data field 202 within the relational structure 200 to be validated may indicate that the party in data field 202 is an individual, data field 204 within the relational structure 200 to be validated may indicate that the party in data field 204 is a business entity, and data field 206 within the relational structure 200 to be validated may indicate that the relationship type is “spouse.” Relational computing platform 110 may validate the contents of data field 206 against the rules in metadata structure 210, and determine that in this instance, the relationship type specified in data field 206 is invalid.

In a second instance, data field 202 of the relational structure 200 to be validated may indicate that the party in data field 202 is a business entity, data field 204 of the relational structure 200 to be validated may indicate that the party in data field 204 is a business entity, and data field 206 of the relational structure 200 to be validated may indicate that the relationship type is “parent company.” Relational computing platform 110 may validate the contents of data field 206 against these rules in metadata structure 210, and determine that in this instance, the relationship type specified in data field 206 is valid. Various other examples of relational structures may be validated without departing from the invention.

As further indicated above, data field 206 indicates a relationship type between the parties in data field 202 and data field 204, and data field 205 may include additional traits of the relationship. One or more data fields of metadata structure 210 may store rules specifying the traits that are valid (or invalid) for each of the different types of relationships. For example, a first rule stored in a data field of metadata structure 210 may indicate that if the party in data field 204 is the spouse of the party in data field 202, valid traits of a “spouse” relationship include beneficiary, power of attorney, dependent, and third-party access. A second rule stored in a data filed of metadata structure 210 may indicate that if the party in data field 204 is the child of the party in data field 202, valid traits of a “child” relationship are limited to beneficiary and dependent. In one instance, data field 202 may indicate that the first party is an individual, data field 204 may indicate that the second party is an individual, data field 206 may indicate that the individual in data field 204 is the child of the individual in data field 202, and data field 205 may list the traits “beneficiary” and “power of attorney.” Relational computing platform 110 may validate the traits listed in data field 205 of the relational structure 200 to be validated against these rules stored in metadata structure 210, and determine that the trait “beneficiary” is valid, while the trait “power of attorney” is invalid.

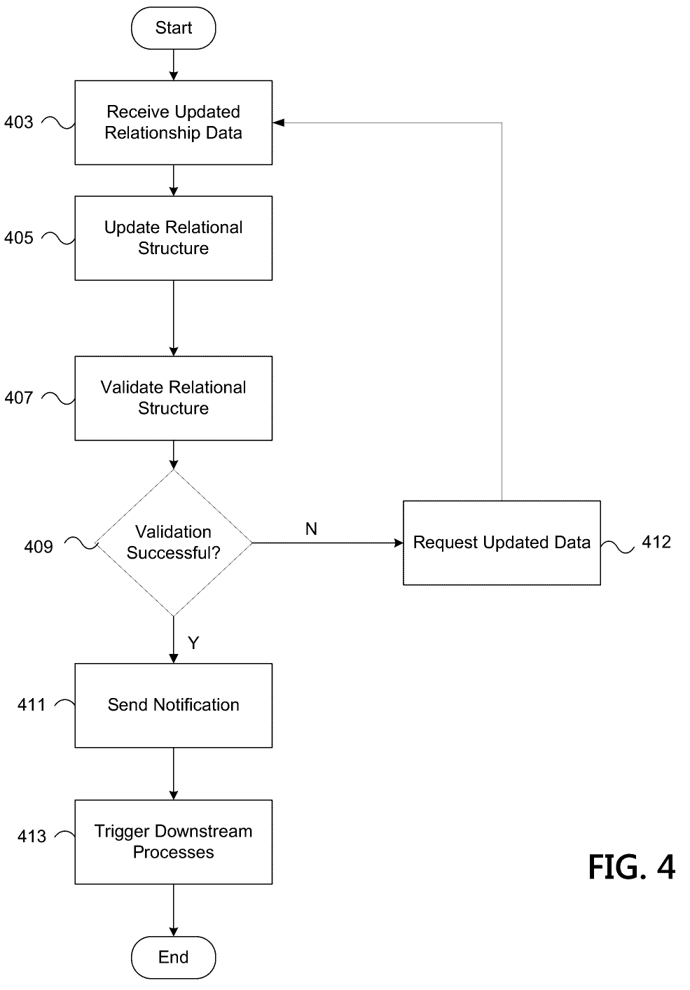

At step 311, relational computing platform 110 may determine if validation of relational structure 200 was successful. If one or more of data field 206 and data field 205 were found to be invalid, then relational computing platform 110 may request updated data at step 312. The request for updated data may be transmitted to the computing device from which the data was initially received, such as first client device 101 or first organization device 104. The request for updated data may be transmitted from relational computing platform 110 to first client device 101 or first organization device 104 via one or more networks, such as the Internet. The request for updated data may be presented to the user of first client device 101 or first organization device 104 in the form of a notification that appears on a display screen of first client device 101 or first organization device 104. The request may indicate the data that was deemed invalid during a validation process (such as the invalid data from data field 205 and/or data field 206). At step 314, the method may then proceed to step 403, shown in FIG. 4.

If relational computing platform 110 determines, at step 311, that the validation of the relational structure 200 was successful, relational computing platform 110 may, at step 313, send a notification to the computing device from which the relationship data was received. The notification may indicate that a relational structure 200 based on the relationship data sent from the computing device has been successfully created and stored in the relational database 115 of the enterprise organization. The notification may be sent from relational computing platform 110 to first client device 101 or first organization device 104 via one or more networks, such as the Internet. The notification may automatically appear on a display screen of first client device 101 or first organization device 104. The notification may further include instructions for how the user of first client device 101 or first organization device 104 may view the stored relational structure 200. For example, the notification may include a link to an online interface which may, for example, be presented on and/or as a part of a website, webpage, portal, and/or other interface that may be electronically communicated and/or displayed to the user. The user of first organization device 104 or first client device 101 may view the created relational structure 200 within the online interface.

Additionally, or alternatively, relational computing platform 110 may send a similar notification to a computing device associated with the enterprise organization, such as second organization device 106. Second organization device 106 may be associated with a first advisor to a client, such as a financial advisor. The first financial advisor may be associated with the party in data field 202 and/or the party in data field 204. The notification may be sent from relational computing platform 110 to second organization device 106 via one or more networks, such as the Internet. The notification may automatically appear on a display screen of second organization device 106. The notification may further include instructions for how the first financial advisor may view the stored relational structure 200. For example, the notification may include a link to an online interface which may, for example, be presented on and/or as a part of a website, webpage, portal, and/or other interface that may be electronically communicated and/or displayed to the user. The first financial advisor may view the created relational structure 200 within the online interface.

The first financial advisor may simultaneously view multiple relational structures 200 associated with the party in data field 202 and/or data field 204. This allows an advisor of an enterprise organization to view relationship information for a client for whom the advisor services or for a non-client. The display provided to the first financial advisor may indicate whether each relational structure 200 contains relationship information for two clients of the enterprise organization (i.e. the party in data field 202 and the party in data field 204 are each a client of the enterprise organization), for a client and a non-client (i.e. one of the parties in data field 202 and data field 204 is a client of the enterprise organization and one of the parties in data field 202 and data field 204 is not a client of the enterprise organization) or for two non-clients (i.e. neither the party in data field 202 nor the party in data field 204 are clients of the enterprise information). This information may be extracted using the identification information stored in data field 202 and data field 404 of each relational structure 200 that is displayed to the first financial advisor. A displayed relational structure 200 that contains information for two clients of the enterprise organization (i.e. the party in data field 202 and the party in data field 204 are each a client of the enterprise organization) may be highlighted or flagged for the first financial advisor.

At step 315, one or more downstream processes based on the relational structure 200 may be triggered. In one instance, relational computing platform 110 may trigger the downstream processes automatically, once relational structure 200 has been validated. In another instance, once the relational structure 200 has been validated, relational computing platform 110 may send a request for permission to trigger the downstream processes to the computing device from which the relationship data was received. The request for permission may be transmitted as part of the notification transmitted to the computing device at step 313, or may be transmitted separately. In another instance, once the relational structure 200 has been validated, relational computing platform 110 may send a request for permission to trigger the downstream processes to a computing device associated with the enterprise organization, such as first organization device 104 or second organization device 106. The request for permission may be transmitted as part of the notification transmitted to the computing device associated with the enterprise organization at step 313, or may be transmitted separately

The request for permission may be sent from relational computing platform 110 to the computing device from which the relationship data was received at step 303, or to a computing device associated with the enterprise organization, via one or more networks, such as the Internet. The request for permission may automatically appear on a display screen of the computing device. The request for permission may further include instructions for how the user of the computing device may grant or deny permission. For example, the request for permission may include a link to an online interface which may, for example, be presented on and/or as a part of a website, webpage, portal, and/or other interface that may be electronically communicated and/or displayed to the user. The user may grant or deny permission to trigger the downstream processes via the online interface in the link.

If multiple downstream processes are to be triggered, a single request for permission to trigger the multiple downstream processes may be sent from relational computing platform 110 to the computing device from which the relationship data was received at step 303, or to a computing device associated with the enterprise organization. The user of the computing device may then individually grant or deny permission to trigger each of the downstream processes. Alternatively, if multiple downstream processes are to be triggered, multiple requests for permission to trigger to the downstream processes may be sent from relational computing platform 110 to the computing device from which the relationship data was received at step 303, or to a computing device associated with the enterprise organization. Each request may include a request for permission to trigger one or more downstream processes. For example, a first request may be sent from relational computing platform 110 to first client device 101 (from which the relationship data was received at step 303) upon successful validation of relational structure 200, and the first request may include a request to trigger a first downstream process. A second request may additionally be sent from relational computing platform 110 to first client device 101 upon successful validation of relational structure 200, and the second request may include a request to trigger a second downstream process and a third downstream process. The user of first client device 101 may grant permission to trigger one or more of the first, second, and third downstream processes, and/or may deny permission to trigger one or more of the first, second, and third downstream processes via an online interface.

If multiple downstream processes are to be triggered, a first subset of the multiple downstream processes may be automatically triggered by relational computing platform 110 upon successful validation of relational structure 200. Relational computing platform 110 may further request permission to trigger a second subset of the multiple downstream processes by sending one or more requests to the computing device from which the relationship data was received at step 303, or to a computing device associated with the enterprise organization. The first subset and the second subset may each include one or more downstream processes.

The downstream processes to be triggered upon successful validation of relational structure 200 by relational computing platform 110 may be previously specified by the enterprise organization. Different downstream processes may have different triggers. In one instance, every time a new relational structure 200 is validated, a first downstream process may be triggered. Additionally, or alternatively, every time a new relational structure 200 including a predetermined relationship trait is validated, a second downstream process and a third downstream process may be triggered. A downstream process may be any operational workflow that has been previously specified by the enterprise organization.

A first exemplary downstream process may be in the form of a notification that is automatically transmitted to an advisor associated with the client of the enterprise organization (for example, an advisor associated with the party in data field 202), such as a financial advisor. This notification may be in addition to the notification that may transmitted sent to the advisor in step 513. A second exemplary downstream process may include the operational workflow needed to assign a party in data field 202 and/or 204 of a relational structure 200 with the trait(s) listed in data field 207 of the relational structure 200. A third exemplary downstream process may be in the form of a notification that is automatically transmitted to a client device associated with the party in data field 202, and/or to a client device associated with the party in data field 204. This notification may be in addition to the notifications that may be transmitted to client device(s) in step 513. For example, the notification transmitted to the client device(s) may be a recommended action for the client that has been determined by relational computing platform 110 in response to the received relationship data. Alternatively, or additionally, a notification containing the recommended action for the client may be transmitted by relational computing platform 110 to an organization device associated with an advisor who is associated with the client, such as first organization device 104 and/or second organization device 106.

Described below are exemplary instances of implementing the system to trigger one or more downstream processes. In a first instance, relational computing platform 110 may validate a first relational structure 200. Data field 206 of the first relational structure 200 may indicate that the party in data field 204 is the child of the party in data field 202. A first entry in data field 205 (i.e. data field 205a) may indicate that the party in data field 204 is the beneficiary of the party in data field 202. A first entry in data field 207 (i.e. data field 207a) may indicate that the party in data field 202 is the holder of a full-service account that is managed by a first financial advisor associated with the enterprise organization. A second entry in data field 207 (i.e. data field 207b) may indicate that the party in data field 204 is the holder of a self-managed checking account.

In this first instance, where the child (the party in data field 204) stands to inherit the full-service account maintained for the parent (the party in data field 202) by the enterprise organization, it is in the interest of the enterprise organization that upon inheriting the account, the child (the party in data field 204) continues to have the account managed by the enterprise organization. Therefore, once the first relational structure 200 is validated by relational computing platform 110, a first downstream process may be triggered. The first downstream process may be in the form of a first notification that is automatically sent to a first organization device 104 associated with the first financial advisor associated with the party in data field 202. The first notification may be sent from relational computing platform 110 to first organization device 104 via one or more networks, such as the Internet. The notification may automatically appear on a display screen of first organization device 104.

The notification may indicate that a first relational structure 200 associated with the party indicated in data field 202 (with whom the first financial advisor is associated by virtue of managing the full-service account held by the party in data field 202) has been validated. The notification may further indicate that a beneficiary has been designated for the full-service account maintained by the first financial advisor and associated with the party in data field 202. The notification may further indicate the identity and contact information of the designated beneficiary (i.e. the party and contact information in data field 204). By receiving such a notification, the first financial advisor may then utilize the contact information to establish a professional relationship with the party in data field 204, thus increasing the likelihood that upon inheriting the account, the child (the party in data field 204) continues to have the full-service account managed by the enterprise organization.

In a second instance, relational computing platform 110 may validate a first relational structure 200. Data field 206 of the first relational structure 200 may indicate that the party in data field 204 is the spouse of the party in data field 202. A first entry in data field 205 (i.e. data field 205a) may indicate that the party in data field 204 is the joint owner of an account listed in data field 207a. After validating first relational structure 200, relational computing platform 110 may trigger a first downstream process. The first downstream process triggered may include the operational workflow needed to designate the party in data field 204 as joint-owner of the account listed in data field 207a. The account listed in data field 207a may be a full-service account maintained for the party in data field 202 by a first financial advisor. The first financial advisor may be associated with the enterprise organization and may further be associated with first organization device 104. Relational computing platform 110 may trigger the first downstream process by sending a trigger to second organization device 106.

The operational workflow to be executed by second organization device 106 as a result of the triggering of the first downstream process may include aggregating one or more forms that need to be completed by the party in data field 202 and/or the party in data field 204. The one or more forms may be propagated with the data that is already in the validated first relational structure 200. For example, the one or more forms may be propagated with the information in data field 202 and data field 204 (the name of the parties, the contact information of the parties), and the information in data fields 206 and 207 (an indication that the party in data field 204 is to be designated as a joint-owner of the account listed in data field 207a). Additionally, second organization device 106 may access additional information from organization server 108, and propagate the one or more forms using the additional information. Once the one or more forms have been propagated with the information from the validated first relational structure 200 and from organization server 108, the forms may be sent to the party in data field 202 and/or the party in data field 204 for any required additional information and signatures. This may complete a first step of the triggered first downstream process in the second instance.

A second step of the triggered first downstream process in the second instance may include the triggering of a second downstream process. As noted above, the account listed in data field 207a may be a full-service account maintained for the party in data field 202 by a first financial advisor. The first financial advisor may be associated with the enterprise organization and may further be associated with first organization device 104. Triggering the second downstream process may include sending, by the second organization device 106, a first notification to the first organization device 104.

The first notification may be sent from second organization device 106 to first organization device 104 via one or more networks, such as the Internet. The notification may automatically appear on a display screen of first organization device 104. The notification may include the validated first relational structure 200, as well as the one or more forms that were created as a result of the triggered first downstream process. The notification may further include instructions for how the first financial advisor associated with first organization device 104 and the full-service account maintained for the party in data field 202 may view the first relational structure 200 and the one or more forms that were created as a result of the triggered first downstream process. For example, the notification may include a link to an online interface which may, for example, be presented on and/or as a part of a website, webpage, portal, and/or other interface that may be electronically communicated and/or displayed to the first financial advisor. The first financial advisor may view the first relational structure 200 and the one or more forms that were created as a result of the triggered first downstream process via the link to the online interface.

In a third instance, relational computing platform 110 may validate a first relational structure 200. Data field 206 of the first relational structure 200 may indicate that the party in data field 204 is the child of the party in data field 202. A first entry in data field 205 (i.e. data field 205a) may indicate that the party in data field 204 is the beneficiary of an account listed in data field 207a. The account listed in data field 207a may be a full-service account maintained for the party in data field 202 by a first financial advisor. The first financial advisor may be associated with the enterprise organization and may further be associated with first organization device 104. After validating first relational structure 200, relational computing platform 110 may trigger a downstream process. The downstream process triggered may include a recommendation to the party in data field 202 to open a college-savings account for the party in data field 204 (for example, a saving plan under section 529 of the Internal Revenue Code (“529 plan”)).

The downstream process triggered in the third instance may take several forms. In a first example of the downstream process triggered in the third instance, relational computing platform 110 may send a first notification to first organization device 104 associated with the first financial advisor. The notification may indicate that a new relational structure 200 associated with the party in data field 202 (for whom the first financial advisor maintains a full-service account) has been created and validated. The notification may further indicate that the party in data field 204 is the child of the party in data field 202 and the beneficiary of the account in data field 207a (maintained by the first financial advisor). The notification may further indicate that it is recommended that the party in data field 204 open a college-savings account for the party in data field 202. The first financial advisor may then contact the party in data field 202 and recommend the opening of a college-savings account for the party in data field 204.

Alternatively, in the first example of the downstream process triggered in the third instance, the notification sent from relational computing platform 110 to the first organization device 104 associated with the first financial advisor may additionally include a request for permission to send a notification associated with the potential creation of a college-savings account to the party in data field 202. If the first financial advisor grants the request, a second notification may be sent from first organization device 104 to a client device associated with the party in data field 202, such as first client device 101. The second notification may be sent from first organization device 104 to first client device 101 via one or more networks, such as the Internet. The notification may automatically appear on a display screen of first client device 101. The notification may include the validated first relational structure 200, as well as the recommendation that a college-savings account be opened for the party in data field 204. The notification may further include instructions for how the party in data field 202 may open the recommended college-savings account for the party in data field 204. For example, the notification may include a link to an online interface which may, for example, be presented on and/or as a part of a website, webpage, portal, and/or other interface that may be electronically communicated and/or displayed to the party in data field 202. The party in data field 202 may use the online interface to open the recommended account.

In a second example of the downstream process triggered in the third instance, relational computing platform 110 may automatically send a first notification to a client device associated with the party in data field 202, such as the first client device 101, thereby bypassing the need to first receive permission to do so from the first financial advisor. The first notification may be sent from relational computing platform 110 to first client device 101 via one or more networks, such as the Internet. The notification may automatically appear on a display screen of first client device 101. The notification may include the validated first relational structure 200, as well as the recommendation that a college-savings account be opened for the party in data field 204. The notification may further include instructions for how the party in data field 202 may open the recommended college-savings account for the party in data field 204. For example, the notification may include a link to an online interface which may, for example, be presented on and/or as a part of a website, webpage, portal, and/or other interface that may be electronically communicated and/or displayed to the party in data field 202. The party in data field 202 may use the online interface to open the recommended account.

In one instance, relational computing platform 110 may automatically create a second relational structure 200 that mirrors the relational structure 200 created in step 305. Relational computing platform 110 may store the data from data field 202 of the relational structure 200 created in step 305 in data field 204 of the second relational structure 200. Relational computing platform 110 may additionally store the data from data field 204 of the relational structure 200 created in step 305 in data field 202 of the second relational structure 200. The data in data field 206 of second relational structure 200 may mirror the data from data field 206 of the relational structure 200 created in step 305. That is, if data field 206 in the relational structure 200 created in step 305 indicates that the party in data field 202 (“P1”) is the parent of the party in data field 204 (“P2”), relational computing platform 110 may store data in data field 206 of the second relational structure 200 indicating that a party in data field 202 (P2) of the second relational structure 200 is the child of the party in data field 204 (P1) of the second relational structure 200. Relational computing platform 110 may propagate data from data fields 205, 207, and 208 of the relational structure 200 created in step 305 to corresponding data fields 205, 207, and 208 of the second relational structure 200 that is automatically created by relational computing platform 110. Relational computing platform 110 may additionally validate and store the automatically created second relational structure 200. The successful creation and validation of the second relational structure 200 may result in the triggering of additional downstream processes. These additional downstream processes may be similar to those discussed above in reference to step 315.

FIG. 4 depicts an illustrative method for updating an existing relational structure. At step 403, relational computing platform 110 may receive updated relationship data. The relational computing platform 110 may receive the updated information from a client device, such as a first client device 101, or from an organization device, such as first organization device 104. The updated relationship data may be received in response to a request for updated data in step 312 of FIG. 3.

As noted above, first client device 101 and first organization device 104 may be any type of computing device configured to receive a user interface, receive input via the user interface, and communicate the received input to one or more other computing devices. For example, first client device 101 and first organization device 104 may be a server computer, a desktop computer, laptop computer, tablet computer, smart phone, or the like. Any and/or all first client device 101 and first organization device 104 may, in some instances, be special-purpose computing devices configured to perform specific functions. A user may input the updated relationship information via the user interface presented on first client device 101 or first organization device 104.

The updated information received by relational computing platform 110 from first client device 101 or first organization device 104 may be associated with any of data field 202, data field 204, data field 206, data field 207, and/or data field 208. For example, data field 206 of relational structure 200 may have originally indicated that the party in data field 204 is the spouse of the party in data field 202, and that the relationship status is “active.” Data field 205a of relational structure 200 may have originally indicated that the party in data field 204 is the beneficiary of an account listed in data field 207a.

In a first instance, relational computing platform 110 may receive updated relationship data from first client device 101. First client device 101 may be associated with the party in data field 202. The updated relationship information may indicate that the party in data field 204 is to be listed as a joint-owner of the account listed in data field 207a.

In a second instance, relational computing platform 110 may receive updated relationship data from first organization device 104. The updated relationship may indicate that the party in data field 202 has opened a new self-managed savings account with the enterprise organization, and that the party in data field 202 has indicated that the party in data field 204 is to be made a beneficiary and a joint owner of the new self-managed savings account opened by the party in data field 202.

At step 405, relational computing platform 110 may update the relational structure. Relational computing platform 110 may update the relational structure 200 using the updated relationship information received from first client device 101 or first organization device 104. In the first instance described above in relation to step 403, to update the original relational structure 200, relational computing platform 110 may create a new data field 205b. Relational computing platform 110 may then store information in 205b indicating that the party in data field 204 is a joint-owner of the account listed in data field 207a.

In the second instance described above in relation to step 403, to update the original relational structure 200, relational computing platform 110 may create a new data field 207b. Relational computing platform 110 may then store information in data field 207b associated with the self-managed savings account held by the party in data field 202 and associated with the enterprise organization. Relational computing platform 110 may additionally create new data fields 205b and 206c. Relational computing platform 110 may then store information in data field 205b indicating that the party in data field 204 is the joint owner of the account listed in data field 207b. Relational computing platform 110 may additionally store information in data field 205c indicating the party in data field 204 is the beneficiary of the account listed in data field 207b.

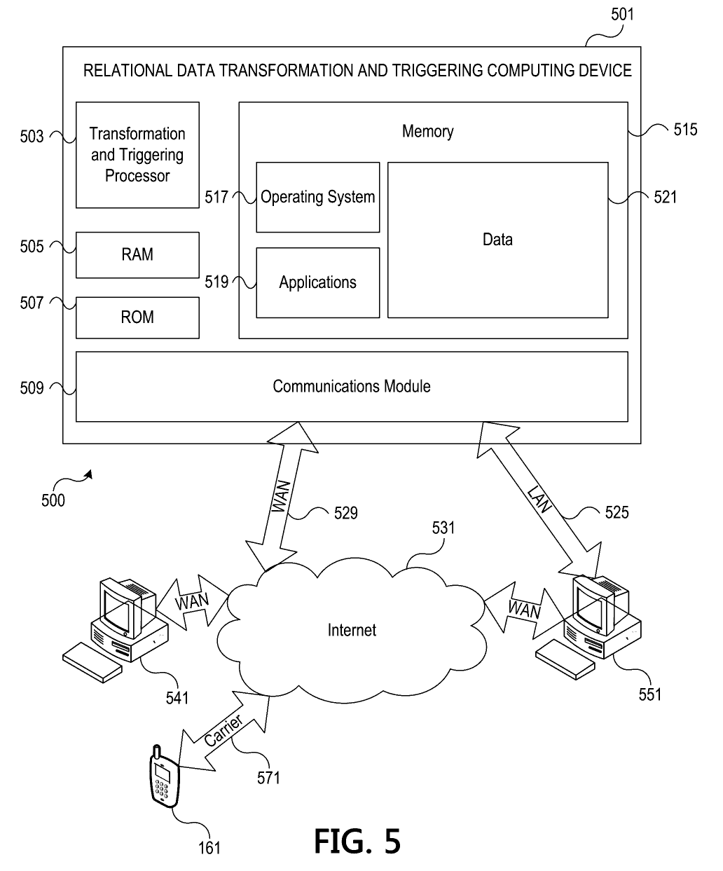

At step 407, relational computing platform 110 may validate the updated relational structure. Updated relational structure 200 may be validated using the metadata structure 210 described above in relation to FIGS. 4 and 5. As described above, each data field within metadata structure 210 may store one or more rules. These rules may be associated with one or more data fields of the updated relational structures 200. Relational computing platform 110 may validate each of data field 202, data field 204, data field 205, data field 206, and data field 207 of the updated relational structure 200 using the same process described above in relation to step 309 of FIG. 3.

At step 409, relational computing platform 110 may determine if validation of the updated relational structure 200 was successful. If validation of the updated relational structure is not successful, relational computing platform 110 may, at step 412, request updated relationship data. The request for updated data may be transmitted to the computing device from which the updated data was initially received (at step 403), such as first client device 101 or first organization device 104. The request for updated data may be transmitted from relational computing platform 110 to first client device 101 or first organization device 104 via one or more networks, such as the Internet. The request for updated data may be presented to the user of first client device 101 or first organization device 104 in the form of a notification that appears on a display screen of first client device 101 or first organization device 104. The request may indicate the data that was deemed invalid during validation (such as the invalid data from data field 205 and/or data field 206). The method may then proceed back to step 403.

If relational computing platform 110 determines, at step 409, that the validation of the updated relational structure 200 was successful, relational computing platform 110 may, at step 411, send one or more notifications regarding the successful validation of the updated relational structure 200. The relational computing platform 110 may send the computing device from which the relationship data was received (at step 403) a notification that an updated relational structure 200 has been validated based on the updated relationship data sent from the computing device. The notification may be sent from relational computing platform 110 to first client device 101 or first organization device 104 via one or more networks, such as the Internet. The notification may automatically appear on a display screen of first client device 101 or first organization device 104. The notification may further include instructions for how the user of first client device 101 or first organization device 104 may view the updated relational structure 200. For example, the notification may include a link to an online interface which may, for example, be presented on and/or as a part of a website, webpage, portal, and/or other interface that may be electronically communicated and/or displayed to the user. The user may view the updated relational structure 200 within the online interface via the link.

Additionally, or alternatively, the relational computing platform 110 may send a notification that an updated relational structure 200 has been validated to a computing device associated with the enterprise organization, such as first organization device 104 or second organization device 106. The notification may be sent from relational computing platform 110 to the computing device associated with the enterprise organization via one or more networks, such as the Internet. The notification may automatically appear on a display screen of the computing device associated with the enterprise organization. The notification may further include instructions for how the user of the computing device associated with the enterprise organization may view the updated relational structure 200. For example, the notification may include a link to an online interface which may, for example, be presented on and/or as a part of a website, webpage, portal, and/or other interface that may be electronically communicated and/or displayed to the user. The user (for example, a financial advisor associated with the party in data field 202 and/or the party in data field 204) may view the updated relational structure 200 within the online interface via the link.

At step 413, relational computing platform 110 may trigger one or more downstream processes based on the successful validation of the updated relational structure 200. The one or more downstream processes triggered based on the successful validation of the updated relational structure 200 may include the downstream processes triggered based on the successful validation of a new relational structure 200, or may be different from the downstream processes triggered based on the successful validation of a new relational structure 200 (discussed with reference to FIG. 3). In one instance, relational computing platform 110 may trigger the downstream processes automatically, once updated relational structure 200 has been validated. In another instance, once the updated relational structure 200 has been validated, relational computing platform 110 may send a request for permission to trigger the downstream processes to the computing device from which the relationship data was received, or to a computing device associated with the enterprise organization. The request for permission may be transmitted as part of or separately from the notification transmitted to the computing device from which the relationship data was received at step 403 and/or the notification transmitted to the computing device associated with the enterprise organization.

The request for permission may be sent from relational computing platform 110 to first client device 101 or first organization device 104 (i.e. the computing device from which the relationship data was received at step 403 or a computing device associated with the enterprise organization) via one or more networks, such as the Internet. The request for permission may automatically appear on a display screen of first client device 101 or first organization device 104. The request for permission may further include instructions for how the user of first client device 101 or first organization device 104 may grant or deny permission. For example, the request for permission may include a link to an online interface which may, for example, be presented on and/or as a part of a website, webpage, portal, and/or other interface that may be electronically communicated and/or displayed to the user.

If multiple downstream processes are to be triggered, a single request for permission to trigger the multiple downstream processes may be sent from relational computing platform 110 to the first client device 101 or first organization device 104 (i.e. the computing device from which the relationship data was received at step 403 or a computing device associated with the enterprise organization.) The user of first client device 101 or first organization device 104 may then individually grant or deny permission to trigger each of the downstream processes. Alternatively, if multiple downstream processes are to be triggered, multiple requests for permission to trigger to the downstream processes may be sent from relational computing platform 110 to the first client device 101 or first organization device 104. Each request may include a request for permission to trigger one or more downstream processes. For example, a first request may be sent from relational computing platform 110 to first client device 101 upon successful validation of updated relational structure 200, and the first request may include a request to trigger a first downstream process. A second request may be sent from relational computing platform 110 to first client device 101 upon successful validation of updated relational structure 200, and the second request may include a request to trigger a second downstream process and a third downstream process. The user of first client device 101 may grant permission to trigger one or more of the first, second, and third downstream processes, and/or may deny permission to trigger one or more of the first, second, and third downstream processes.

If multiple downstream processes are to be triggered, a first subset of the multiple downstream processes may be automatically triggered by relational computing platform 110 upon successful validation of updated relational structure 200. Relational computing platform 110 may then request permission to trigger a second subset of the multiple downstream processes by sending one or more requests to first client device 101 or first organization device 104 (i.e. the computing device from which the relationship data was received at step 403 or a computing device associated with the enterprise organization.) The first subset and the second subset may each include one or more downstream processes.

The downstream processes to be triggered upon successful validation of updated relational structure 200 by relational computing platform 110 may be previously specified by the enterprise organization. Different downstream processes may have different triggers. In one instance, every time data field 205 is updated within a relational structure 200, a first downstream process may be triggered. Additionally, or alternatively, every time data field 207 within a relational structure 200 is updated to include a predetermined relationship trait, a second downstream process and a third downstream process may be triggered once the updated relational structure 200 is validated. A downstream process may be any operational workflow that has been previously specified by the enterprise organization.

As discussed above in reference to step 403, data field 206 of relational structure 200 may have originally indicated that the party in data field 204 is the spouse of the party in data field 202, and that the relationship status is “active.” Data field 205a of relational structure 200 may have originally indicated that the party in data field 204 is the beneficiary of an account listed in data field 207a.

As further discussed above in reference to steps 403 and 405, in the first instance, relational computing platform 110 may receive updated relationship data from first client device 101. First client device 101 may be associated with the party in data field 202. The updated relationship information may indicate that the party in data field 204 is to be listed as a joint-owner of the account listed in data field 207a. Relational computing platform 110 may create a new data field 205b. Relational computing platform 110 may then store information in 205b indicating that the party in data field 204 is a joint-owner of the account listed in data field 207a.

In this first instance, once updated relational structure 200 has been validated, relational computing platform 110 may trigger a first downstream process by sending a trigger to second organization device 106. The operational workflow to be executed by second organization device 106 as a result of the triggering of the first downstream process may include aggregating one or more forms that need to be completed by the party in data field 202 and/or the party in data field 204 in order to designate the party in 204 as joint owner of the account associated with the party in data field 202 and listed in data field 207a of updated relational structure 200. The one or more forms may be propagated with the data that is stored in the validated updated relational structure 200. For example, the one or more forms may be propagated with the information in data field 202 and data field 204 (the name of the parties, the contact information of the parties), and the information in data fields 206 and 207 (an indication that the party in data field 204 is to be designated as a joint-owner of the account listed in data field 207a). Additionally, second organization device 106 may access additional information from organization server 108, and propagate the one or more forms using the additional information. Once the one or more forms have been propagated with the information from the validated first relational structure 200 and from organization server 108, the forms may be sent to the party in data field 202 and/or the party in data field 204 for any required additional information and signatures. This may complete a first step of the triggered first downstream process.

A second step of the triggered first downstream process may include the triggering of a second downstream process. The account listed in data field 207a may be a full-service account maintained for the party in data field 202 by a first financial advisor. The first financial advisor may be associated with the enterprise organization and may further be associated with first organization device 104. Triggering the second downstream process may include sending, by the second organization device 106, a first notification to the first organization device 104.

The first notification may be transmitted from second organization device 106 to first organization device 104 via one or more networks, such as the Internet. The notification may automatically appear on a display screen of first organization device 104. The notification may include the validated updated relational structure 200, as well as the one or more forms that were created as a result of the triggered first downstream process. The notification may further include instructions for how the first financial advisor that maintains the full-service account for the party in data field 202 and that is associated with first organization device 104 may view the updated relational structure 200 and the one or more forms that were created as a result of the triggered first downstream process. For example, the notification may include a link to an online interface which may, for example, be presented on and/or as a part of a website, webpage, portal, and/or other interface that may be electronically communicated and/or displayed to the first financial advisor. The first financial advisor may view the updated relational structure 200 and the one or more forms that were created as a result of the triggered first downstream process within the online interface.

As further discussed above in reference to steps 403 and 405, in the second instance, relational computing platform 110 may receive updated relationship data from first organization device 104 indicating that the party in data field 202 has opened a new self-managed savings account with the enterprise organization, and that the party in data field 202 has indicated that the party in data field 204 is to be made a beneficiary and a joint owner of the new self-managed savings account opened by the party in data field 202. Relational computing platform 110 may create a new data field 207b and new data fields 205b and 206c. Relational computing platform 110 may then store information in data field 207b associated with the self-managed savings account held by the party in data field 202 and associated with the enterprise organization, store information in data field 205b indicating that the party in data field 204 is the joint owner of the account listed in data field 207b, and store information in data field 205c indicating the party in data field 204 is the beneficiary of the account listed in data field 207b.

In this second instance, once updated relational structure 200 has been validated, relational computing platform 110 may trigger a first downstream process and a second downstream process by sending a trigger to second organization device 106. Alternatively, relational computing platform 110 may trigger a first downstream process by sending a first trigger to second organization device 106 and may trigger the second downstream process by sending a second trigger to the second organization device 106 or a third organization device.

The operational workflow to be executed by second organization device 106 as a result of the triggering of the first downstream process may include aggregating one or more forms that need to be completed by the party in data field 202 and/or the party in data field 204 in order to designate the party in 204 as joint owner of the account associated with the party in data field 202 and listed in data field 207a of updated relational structure 200. The one or more forms may be propagated with the data that is stored in the validated updated relational structure 200. For example, the one or more forms may be propagated with the information in data field 202 and data field 204 (the name of the parties, the contact information of the parties), and the information in data fields 206 and 207 (an indication that the party in data field 204 is to be designated as a joint-owner of the account listed in data field 207a). Additionally, second organization device 106 may access additional information from organization server 108, and propagate the one or more forms using the additional information. Once the one or more forms have been propagated with the information from the validated first relational structure 200 and from organization server 108, the forms may be sent to the party in data field 202 and/or the party in data field 204 for any required additional information and signatures. This may complete a first step of the triggered first downstream process.

A second step of the triggered first downstream process may include the triggering of a third downstream process. The account listed in data field 207a may be a full-service account maintained for the party in data field 202 by a first financial advisor. The first financial advisor may be associated with the enterprise organization and may further be associated with first organization device 104. Triggering the third downstream process may include sending, by the second organization device 106, a first notification to the first organization device 104.

The first notification may be sent from second organization device 106 to first organization device 104 via one or more networks, such as the Internet. The notification may automatically appear on a display screen of first organization device 104. The notification may include the validated updated relational structure 200, as well as the one or more forms that were created as a result of the triggered first downstream process. The notification may further include instructions for how the first financial advisor associated with first organization device 104 and the full-service account maintained for the party in data field 202 may view the first relational structure 200 and the one or more forms that were created as a result of the triggered first downstream process. For example, the notification may include a link to an online interface which may, for example, be presented on and/or as a part of a website, webpage, portal, and/or other interface that may be electronically communicated and/or displayed to the first financial advisor. The first financial advisor may then view the first relational structure 200 and the one or more forms that were created as a result of the triggered first downstream process within the online interface.

The operational workflow to be executed by second organization device 106 as a result of the triggering of the second downstream process may include aggregating one or more forms that need to be completed by the party in data field 202 and/or the party in data field 204 in order to designate the party in 204 as a beneficiary of the account associated with the party in data field 202 and listed in data field 207b of updated relational structure 200. The one or more forms may be propagated with the data that is stored in the validated updated relational structure 200. For example, the one or more forms may be propagated with the information in data field 202 and data field 204 (the name of the parties, the contact information of the parties), and the information in data fields 206 and 207 (an indication that the party in data field 204 is to be designated as a beneficiary of the account listed in data field 207b). Additionally, second organization device 106 may access additional information from organization server 108, and propagate the one or more forms using the additional information. Once the one or more forms have been propagated with the information from the validated first relational structure 200 and from organization server 108, the forms may be sent to the party in data field 202 and/or the party in data field 204 for any required additional information and signatures. This may complete a first step of the triggered second downstream process.

A second step of the triggered second downstream process may include the triggering of a fourth downstream process. Triggering the fourth downstream process may include sending, by the second organization device 106, a first notification to first client device 101. First client device 101 may be associated with the party in data field 202 or the party in data field 204.

The first notification may be sent from second organization device 106 to first client device 101 via one or more networks, such as the Internet. The notification may automatically appear on a display screen of first client device 101. The notification may include the validated updated relational structure 200, as well as the one or more forms that were created as a result of the triggered first downstream process. The notification may further include instructions for how the user of first client device 101 may view the updated relational structure 200 and the one or more forms that were created as a result of the triggered second downstream process. For example, the notification may include a link to an online interface which may, for example, be presented on and/or as a part of a website, webpage, portal, and/or other interface that may be electronically communicated and/or displayed to the user of first client device 101.

FIG. 5 depicts an illustrative relational data transformation and triggering environment in which various aspects of the present disclosure may be implemented in accordance with one or more example embodiments. Referring to FIG. 5, computing system environment 500 may be used according to one or more illustrative embodiments. Computing system environment 500 is one example of a suitable computing environment. Computing system environment 500 should not be interpreted as having any dependency or requirement relating to any one or combination of components shown in illustrative computing system environment 500.

Computing system environment 500 may include relational data transformation and triggering computing device 501 having processor 503 for controlling overall operation of computing device 501 and its associated components, including random-access memory (RAM) 505, read-only memory (ROM) 507, communications module 509, and memory 515. Relational data transformation and triggering computing device 501 may include a variety of computer readable media. Computer readable media may be any available media that may be accessed by computing device 501, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by relational data transformation and triggering computing device 501.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on relational data transformation and triggering computing device 501. Such a processor may execute computer-executable instructions stored on a computer-readable medium.

Software may be stored within memory 515 and/or storage to provide instructions to processor 503 for enabling relational data transformation and triggering computing device 501 to perform various functions. For example, memory 515 may store software used by relational data transformation and triggering computing device 501, such as operating system 517, application programs 519, and associated database 521. Also, some or all of the computer executable instructions for relational data transformation and triggering computing device 501 may be embodied in hardware or firmware. Although not shown, RAM 505 may include one or more applications representing the application data stored in RAM 505 while relational data transformation and triggering computing device 501 is on and corresponding software applications (e.g., software tasks) are running on relational data transformation and triggering computing device 501.

Communications module 509 may include a microphone, keypad, touch screen, and/or stylus through which a user of relational data transformation and triggering computing device 501 may provide input, and may also include one or more of a speaker for providing audio output and a video display device for providing textual, audiovisual and/or graphical output. Relational data transformation and triggering computing device 500 may also include optical scanners (not shown). Exemplary usages include scanning and converting paper documents, e.g., correspondence, receipts, and the like, to digital files.

Relational data transformation and triggering computing device 501 may operate in a networked environment supporting connections to one or more remote computing devices, such as computing devices 541, 551, and 561. Computing devices 541, 551, and 561 may be personal computing devices or servers that include any or all of the elements described above relative to relational data transformation and triggering computing device 501. Computing device 561 may be a mobile device (e.g., smart phone) communicating over wireless carrier channel 571.

The network connections depicted in FIG. 5 may include local area network (LAN) 525 and wide area network (WAN) 529, as well as other networks. When used in a LAN networking environment, relational data transformation and triggering computing device 501 may be connected to LAN 525 through a network interface or adapter in communications module 109. When used in a WAN networking environment, relational data transformation and triggering computing device 501 may include a modem in communications module 509 or other means for establishing communications over WAN 529, such as Internet 531 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other special purpose computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

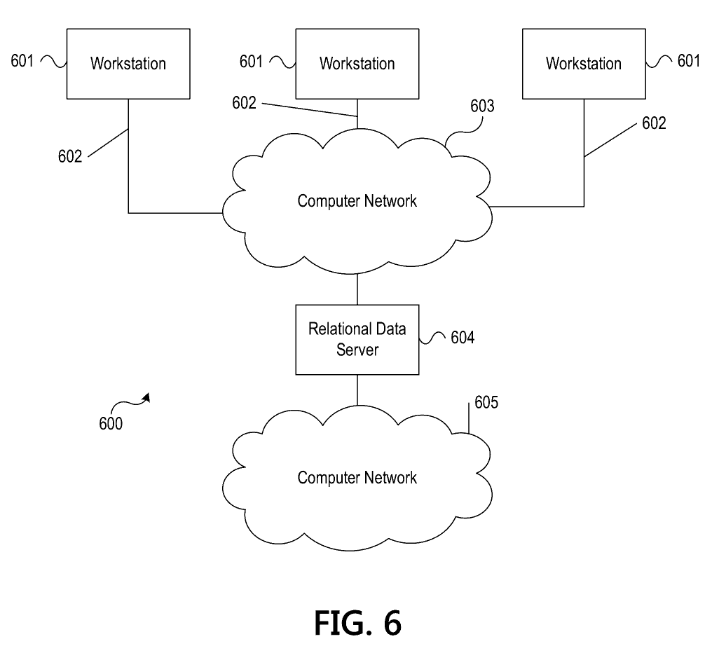

FIG. 6 depicts an illustrative block diagram of workstations and servers that may be used to implement the processes and functions of certain aspects of the present disclosure in accordance with one or more example embodiments. Referring to FIG. 6, illustrative system 600 may be used for implementing example embodiments according to the present disclosure. As illustrated, system 600 may include one or more workstation computers 601. Workstation 601 may be, for example, a desktop computer, a smartphone, a wireless device, a tablet computer, a laptop computer, and the like. Workstations 601 may be local or remote, and may be connected by one of communications links 602 to computer network 603 that is linked via communications link 605 to relational data server 604. In system 600, relational data server 604 may be any suitable server, processor, computer, or data processing device, or combination of the same. Relational data server 604 may be used to process the instructions received from, and the transactions entered into by, one or more participants.

Computer network 603 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 602 and 605 may be any communications links suitable for communicating between workstations 601 and relational data server 604, such as network links, dial-up links, wireless links, hard-wired links, as well as network types developed in the future, and the like.

One or more aspects of the disclosure may be embodied in computer-usable data or computer-executable instructions, such as in one or more modules, executed by one or more computers or other devices to perform the operations described herein. Generally, modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
at least one processor;
a communication interface; and
memory storing computer-readable instructions that, when executed by the at least one processor, cause the system to:
receive, from a first computing device, relationship information defining a relationship between two clients, the relationship information comprising a relationship type and one or more relationship traits;
create a new relational structure within a central database;
propagate one or more data fields of the new relational structure with the relationship information; and
trigger one or more workflow processes based on the relationship information.

2. The system of claim 1, wherein the memory stores additional computer-readable instructions that, when executed by the at least one processor, further cause the system to validate the new relational structure using one or more constraints stored in the central database.

3. The system of claim 2, wherein a first constraint of the one or more constraints restricts permissible relationship traits based on the relationship type.

4. The system of claim 2, wherein the memory stores additional computer-readable instructions that, when executed by the at least one processor, further cause the system to automatically transmit, to the first computing device and in response to the new relational structure being successfully validated, a notification indicating that the new relational structure has been created.

5. The system of claim 2, wherein the memory stores additional computer-readable instructions that, when executed by the at least one processor, further cause the system to automatically transmit, to the first computing device and in response to the new relational structure failing to be validated, a request for updated relationship data.

6. The system of claim 1, wherein triggering one or more workflow processes based on the relationship information comprises automatically sending a trigger to a second computing device.

7. The system of claim 1, wherein triggering one or more workflow processes based on the relationship information comprises sending a request for permission to trigger the one or more workflow processes to the first computing device.

8. The system of claim 1, wherein triggering one or more workflow processes based on the relationship information comprises:
transmitting a trigger for a first downstream process to a second computing device; and
triggering, by the second computing device, a second downstream process.

9. The system of claim 8, wherein triggering, by the second computing device, a second downstream process comprises sending, by the second computing device, a notification to the first computing device.

10. A method, comprising:
at a first computing platform comprising at least one processor, a communication interface, and memory:
receiving, from a first computing device, relationship information defining a relationship between two clients, the relationship information comprising a relationship type and one or more relationship traits;
creating a new relational structure within a central database;
propagating one or more data fields of the new relational structure with the relationship information; and
triggering one or more workflow processes based on the relationship information.

11. The method of claim 10, further comprising validating the new relational structure using one or more constraints stored in the central database.

12. The method of claim 11, further comprising transmitting, to the first computing device and in response to the new relational structure being successfully validated, a notification indicating that the new relational structure has been created.

13. The method of claim 11, further comprising automatically transmitting, to the first computing device and in response to the new relational structure failing to be validated, a request for updated relationship data.

14. The method of claim 10, wherein triggering one or more workflow processes based on the relationship information comprises automatically sending a trigger to a second computing device.

15. The method of claim 14, wherein triggering one or more workflow processes based on the relationship information comprises sending a request for permission to trigger the one or more workflow processes to the first computing device.

16. The method of claim 10, wherein triggering one or more workflow processes based on the relationship information comprises:
transmitting a trigger for a first downstream process to a second computing device; and
triggering, by the second computing device, a second downstream process.

17. The method of claim 16, wherein triggering, by the second computing device, a second downstream process comprises sending, by the second computing device, a notification to the first computing device.

18. One or more non-transitory computer-readable media storing instructions that, when executed by a computer system comprising at least one processor and memory, cause the computer system to:
receive, from a first computing device, relationship information defining a relationship between two clients, the relationship information comprising a relationship type and one or more relationship traits;
create a new relational structure within a central database;
propagate one or more data fields of the new relational structure with the relationship information; and
trigger one or more workflow processes based on the relationship information.

19. The one or more non-transitory computer-readable media of claim 18 storing additional computer-readable instructions that, when executed by the processor, further cause the computing system to validate the new relational structure using one or more constraints stored in the central database.

20. The one or more non-transitory computer-readable media of claim 19 storing additional computer-readable instructions that, when executed by the processor, further cause the computing system to automatically transmit, to the first computing device and in response to the new relational structure being successfully validated, a notification indicating that the new relational structure has been created.
